(19) United States
(12) Patent Application Publication
(10) Pub. No.: US 2025/0277724 A1
(43) Pub. Date: Sep. 4, 2025

(54) TISSUE LABELING USING ION EXCHANGE RESIN TO CONTROL BINDING AFFINITY SWEEP

(71) Applicant: LIFECANVAS TECHNOLOGIES INC., Cambridge, MA (US)

(72) Inventors: Zachary Thaddeus Woods, Cambridge, MA (US); Brian Nguyen, Cambridge, MA (US)

(21) Appl. No.: 19/064,516

(22) Filed: Feb. 26, 2025

Related U.S. Application Data
(60) Provisional application No. 63/559,872, filed on Feb. 29, 2024.

(51) Int. Cl. G01N 1/31

(52) U.S. Cl. CPC G01N 1/312

(57) ABSTRACT

A tissue labeling device, method of operation, and a tissue labeling kit enables tissue labeling for microscopy imaging with high labeling depth and uniformity. A tissue labeling device circulates a labeling solution through a tissue sample and concurrently circulates the labeling solution through an ion exchange resin. An ion exchange process increases the binding affinity of the labeling probes in the labeling solution over time as the labeling solution penetrates deeper into the tissue sample. A tissue labeling kit may operate on similar principles. The tissue labeling kit includes a container (e.g., a tube) having an ion exchange resin layer and a hydrogel layer over the ion exchange resin layer. The labeling solution and tissue sample is added to the container to enable the binding affinity sweep in which the hydrogel operates to control the sweep rate of the binding affinity.

### CROSS-REFERENCE TO RELATED APPLICATIONS

This application claims the benefit of U.S. Patent Provisional Application No. 63/559,872 filed on Feb. 29, 2024, which is incorporated by reference herein.

### BACKGROUND

Tissue labeling is a technique used in microscopy applications to enhance visibility of structures in tissue samples for imaging. Technical advances in tissue preparation and imaging techniques have enabled rapid, high-resolution imaging of large, intact biological samples. However, it remains difficult to achieve uniform labeling of specific biomolecules in these intact samples. Ex vivo delivery of antibodies or molecular dyes relies on simple diffusion of labeling probes (molecules) into the tissue. In many cases antibodies remain the gold standard for specific labeling of protein antigens. However, the relatively large size of immunoglobulin G antibodies (IgGs) means their diffusion into the tissue is slow. This slow diffusion coupled with the high affinity of antibodies often results in the depletion of antibodies from the solution as they diffuse into the sample, and therefore a non-uniform labeling profile. In this case, the majority labeling probes are used up by the antigens on the surface of the sample before they are able to diffuse into the depth of the tissue.

### BRIEF DESCRIPTION OF THE DRAWINGS

FIG. 1 is an example embodiment of a tissue labeling device.

FIG. 2 is an example embodiment of an electronics system for a tissue labeling device.

FIG. 3 is a flowchart illustrating an example embodiment of a process for operating a tissue labeling device.

FIG. 4 is an example embodiment of an ion exchange resin attachment for a tissue labeling device.

FIG. 5 is an example embodiment of tissue labeling kit for performing tissue labeling.

FIG. 6 is a flowchart illustrating an example embodiment of a process for performing tissue labeling using a tissue labeling kit.

FIG. 7 is a plot illustrating a rate of change of binding affinity associated with a tissue labeling process for achieving uniform tissue labeling.

FIG. 8 is a first set of example images comparing labeling uniformity of a mouse brain using different labeling techniques.

FIG. 9 is a second set of example images comparing labeling uniformity of a mouse brain using different labeling techniques.

FIG. 10 is a plot illustrating comparing labeling profiles under different labeling techniques relative to an ideal labeling profile.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. Wherever practicable, similar or like reference numbers may be used in the figures and may indicate similar or like functionality.

The disclosed embodiments include a tissue labeling device, method of operation, and a tissue labeling kit for tissue labeling with high labeling depth. In the disclosed embodiments, the binding affinity of labeling probes are reliably swept in a controlled manner to achieve high uniformity of labeling in large, intact tissues. An ion-exchange resin interacts with the labeling solution to gradually introduce ions into the labeling solution that cause the binding affinity of the labeling probes to increase over time. Thus, the binding affinity may initially be low and may increase as the labeling solution penetrates deeper into the tissue sample, thereby preventing labeling probes from concentrating on the tissue surface and enabling uniform labeling. In an example embodiment, the rate of change of the binding affinity may increase over time such that the binding affinity increases slowly at first and increases more rapidly after the labeling solution penetrates deep into the tissue sample.

In an embodiment, a device circulates a labeling solution through a tissue sample and concurrently circulates the labeling solution through an ion exchange resin column. The binding affinity of the labeling probes in the labeling solution increase over time as the labeling solution interacts with the ion exchange resin. The device may regulate the rate of change in binding affinity, in part by controlling flow rate of the labeling solution through the ion exchange resin column. The device may also employ electrophoresis to increase diffusion of the labeling probes into the tissue sample and may control temperature within the labeling chamber to achieve the desired effect.

In another embodiment, a tissue labeling kit includes a container (e.g., a tube) having an ion exchange resin layer and a hydrogel layer over the ion exchange resin layer. When ready to prepare a tissue sample for labeling, the tissue sample is deposited in the container together with a labeling solution that includes labeling probes. The labeling solution initially includes ions that inhibit the binding affinity of the labeling probes and therefore allow the labeling solution to penetrate the tissue sample. Over time, an ion exchange occurs between the ion exchange resin and the labeling solution by diffusion of ions through the hydrogel layer, which operates to gradually increase binding affinity of the labeling probes.

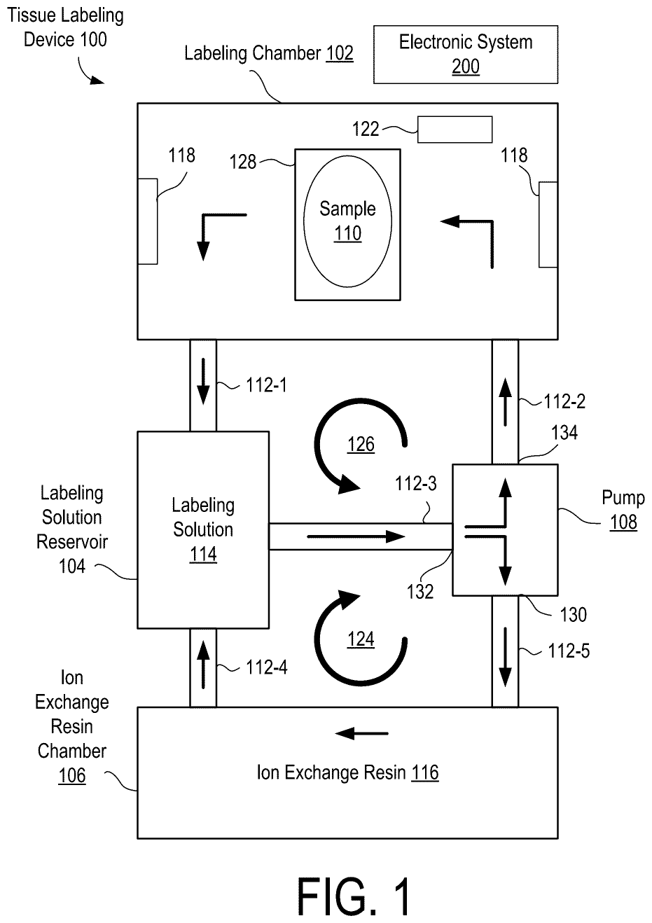

FIG. 1 is an example embodiment of a tissue labeling device 100. The tissue labeling device includes a labeling chamber 102, a labeling solution reservoir 104, an ion exchange resin chamber 106, a pump 108, and a set of channels 112-1, . . . 112-5 (collectively referenced herein as channels 112) for enabling fluid flow between the labeling chamber 102, the labeling solution reservoir 104, the ion exchange resin chamber 106, and the pump 108.

The labeling solution reservoir 104 comprises a refillable chamber for storing a labeling solution 114. The labeling solution 114 may include a liquid buffer with molecules probes designed to specifically bind to certain target proteins, organelles, or other biomolecules in the tissue sample 110. Examples of labeling probes may include fluorophore conjugated IgG antibodies, nuclear dyes, fluorophore conjugated lectins, fluorophore conjugated oligos, or lipophilic dyes. Different types of labeling solutions 114 with different labeling probes may be used dependent on the type of tissue sample 110 and desired targets. The labeling solution 114 may initially include a significant concentration of ions (i.e. charged molecules) such as H+ or OH− that affect pH of the labeling solution 114 and inhibit binding affinity of the labeling probes. The labeling solution may also include d-sorbitol, amino acids, sodium deoxycholate, charged binding inhibitors, and/or other components. In other examples, the labeling solution 114 may initially include one or more binding affinity inhibitors such as, for example, weak acids or bases, ionic detergents, or salts. Depending on the type of tissue for labeling, the labeling solution 114 may comprise an initially high pH or an initially low pH, either of which may inhibit binding affinity.

The ion exchange resin chamber 106 comprises a chamber for storing an ion exchange resin 116. The ion exchange resin 116 includes molecules that interact with the labeling solution 114 to neutralize the pH of the labeling solution 114, which increases the binding affinity of the labeling probes. For example, the ion exchange resin 116 may operate to remove ions from the labeling solution 114 and/or introduce ions to the labeling solution 114. For example, in some reactions, a labeling solution 114 with an initially high pH (i.e. basic) may be lowered to neutral or near neutral as it interacts with the ion exchange resin 116. In other examples, a labeling solution 114 with an initially low pH (i.e., acidic) may be raised to neutral or near neutral as it interacts with the ion exchange resin 116. Once neutralized, the labeling solution 114 may have a pH of 7.0 at 25° C. or within a range sufficient to achieve the appropriate binding affinity and corresponding labeling uniformity suitable for the imaging application (e.g., a range of 6.9-7.1, 6.8-7.2, or other suitable range). Depending on temperature of the labeling solution 114 during the reaction, a different pH or pH range may correspond to a neutral pH suitable for achieving the binding affinity and corresponding labeling uniformity suitable for the imaging application. The amount and type of resin 116 employed to transform the low binding affinity labeling solution into high binding affinity labeling solution may be determined dependent on various factors such as the volume and type of labeling solution, pump speed, temperature, or other factors.

The labeling chamber 102 comprises a structure for removably holding a tissue sample 110 and for enabling fluid flow of the labeling solution 114 through the labeling chamber 102. In an example implementation, the tissue sample 110 may be placed in a sample cup having a nanoporous membrane 128 that can be removably inserted into the labeling chamber 102. The nanoporous membrane 128 may operate to contain labeling probes in a defined volume or to selectively allow diffusion of labeling solution components into and out of the sample cup.

In an embodiment, the labeling chamber 102 may include a set of electrodes 118 for generating an electric field within the labeling chamber 102. The electric field operates to drive charged labeling probes into the tissue sample 110, which may increase labeling speed and uniformity. Furthermore, in examples where the labeling solution 114 has an initially high pH to inhibit binding affinity, the electrolytic reaction may produce an acidic byproduct that reduces the pH of the labeling solution and may operate in conjunction with the ion exchange resin to increase binding affinity over time. For example, in one type of labeling solution 114, d-sorbitol (a component of the solution) breaks down at the electrodes into an acid which neutralizes the initially high pH while the detergent diffuses through a nanoporous membrane 128. This electrolytic reaction may be controlled together with the ion exchange process to achieve a controlled rate of increase in binding affinity.

The labeling chamber 102 may furthermore include one or more temperature control elements 122 (e.g., temperature sensor, heating element, and/or cooling element) that may operate to control temperature in the labeling chamber 102 within a desired temperature range suitable for labeling. For example, the temperature control elements 122 may operate to compensate for Joule heating caused by the electrophoresis.

The pump 108 operates to pump the labeling solution 114 between the labeling solution reservoir 104, the ion exchange resin chamber 106, the labeling chamber 102, and the various channels 112. In one such implementation, the pump 108 operates to circulate the labeling solution through two parallel circulation paths 124, 126: a first circulation path 124 between the labeling solution reservoir and the ion exchange resin chamber 106, and a second circulation path 126 between the labeling solution reservoir 104 and the labeling chamber 102. For example, in one implementation, the pump 108 includes an inlet 132 coupled to the labeling solution reservoir 104 via a channel 112-3 and a first outlet 130 for pumping the labeling solution 114 into the ion exchange resin chamber 106 via a channel 112-5. The labeling solution 114 returns to the labeling solution reservoir 104 via a channel 112-4. The pump 108 also includes a second outlet 134 for pumping the labeling solution into the labeling chamber 102 via a channel 112-2. In this circulation path 126, the labeling solution 114 returns to the labeling solution reservoir 104 via a channel 112-1.

The tissue labeling device 100 may furthermore include an electronics system 200 that enables various electronic control of the device 100. The electronics system 200 may be implemented using one or more integrated circuits mounted to a printed circuit board, such as one or more microcontrollers, one or more general purpose processors (CPUs), one or more display processors (GPUs), one or more field-programmable gate arrays (FPGAs), one or more application specific integrated circuits (ASICs), one or more memory chips, and various supporting circuits including analog circuits, digital circuits, power control circuits, etc. One or more aspects of the electronics system 200 may be implemented in software and/or firmware. Here, the electronic system 200 may include a non-storage computer-readable storage medium that stores computer-executable instructions that when executed by one or more processors cause the processors to carry out the functions described herein.

The tissue labeling device 100 may be operated with various controllable operating parameters that affect the rate of permeability of the labeling probes into the tissue sample 110 and the rate of change in binding affinity of the labeling probes. These various parameters may be controlled to achieve labeling uniformity for tissue samples 110 of various types, thicknesses, and target structures. For example, the rate of change binding affinity may be controlled based on the composition and volume of the ion exchange resin 116, the composition and volume of the labeling solution 114, the flow rate of the pump 108, the voltage and/or current output of the electrodes 118 affecting the electrolytic reaction, the temperature in the labeling chamber 102, the permeability of the membrane 128 around the tissue sample 110, environmental factors such as humidity, bubble formation or instability of other liquid components, or other factors. The electronic system 200 may enable electronic control of the pump 108, the electrodes 118, and the temperature control element 122 to variably control these elements in conjunction with the choice of labeling solution 114, ion exchange resin 116, and other physical components affecting the reaction.

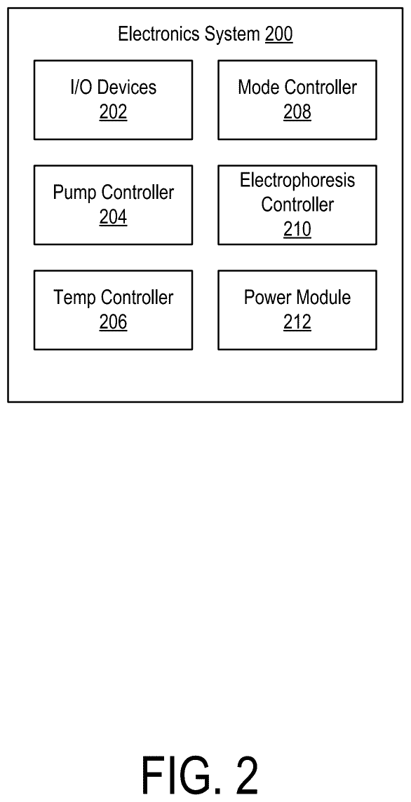

FIG. 2 is an example embodiment of an electronic system 200 for a tissue labeling device 100. The electronic system 200 may include one or more input/output devices 202, a mode controller 208, a pump controller 204, an electrophoresis controller 210, a temperature controller 206, and a power module 212.

The I/O devices 202 may include one or more buttons, dials, knobs, touchscreens, remote controllers, or other mechanisms for providing user input to the tissue labeling device 100. The I/O devices 202 may control various settings or operations such as starting or stopping the pump, controlling the pump speed, controlling temperature, controlling voltages and/or currents for electrophoresis, controlling time durations for labeling processes, etc. The I/O devices 202 may furthermore include one or more visual or audio indicators such as a light emitting diode (LED), liquid crystal display (LCD) screen, speaker, or other output device that may provide visual or audio information about device status, current settings, etc.

The mode controller 208 may control an operating mode of the tissue labeling device 100. For example, the mode controller 208 may control switching between one or more different labeling modes that may be configured with different settings (e.g., pump speed, time duration, etc.) and may be suitable for labeling different types of tissue. In some implementations, the tissue labeling device 100 may also be operable in a tissue clearing mode. In this mode, a clearing buffer may be used in place of the labeling solution 114 to perform tissue clearing prior to labeling.

The pump controller 204 may control operation of the pump 108. For example, the pump controller 204 may control and on/off state of the pump, a pump speed, an operating duration, or other setting of the pump 108. In an embodiment, the pump controller 204 may operate in conjunction with the mode controller 208 to control the pump according to the selected mode.

The electrophoresis controller 210 may control electrophoresis applied in the labeling chamber 102. For example, the electrophoresis controller 210 may control an on/off state of the electrodes 118 in the labeling chamber 102, a voltage and/or current applied in the labeling chamber 102, a duration of voltage and/or current, or other operating conditions. The electrophoresis controller 210 may operate in conjunction with the mode controller 208 to control the electrodes 118 according to the selected mode.

The temperature controller 206 may control temperature within the labeling chamber 102. For example, the temperature controller 206 may receive temperature measurements from one or more temperatures sensors within the labeling chamber 102 and control a heating element (e.g., a thermoelectric heater) and/or a cooling element (e.g., a thermoelectric cooler) to adjust temperature to a desired set temperature or temperature range.

The power module 212 supplies power to the pump 108 and various components of the electronic system 200. The power module 212 may convert power from a power source (e.g., an outlet or battery) to appropriate voltages and/or currents associated with the elements of the electronic system 200 and the pump 108.

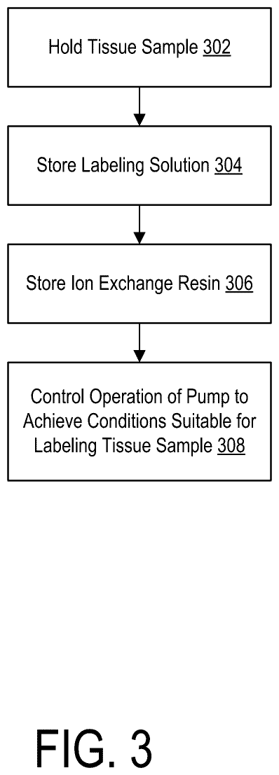

FIG. 3 is a flowchart illustrating operation of the tissue labeling device 100 of FIG. 1. The tissue labeling device 100 holds 302 the sample tissue in the labeling chamber 102, stores 304 labeling solution 114 in a labeling solution reservoir 104, and stores 306 an ion exchange resin 116 in a resin chamber 106. The labeling solution 114 and ion exchange resin 116 may be replaced as needed (e.g., after each labeling operation). Once loaded, the tissue labeling device 100 controls 308 operation of the pump 108 to circulate the labeling solution 114 through the resin chamber 106 and through the labeling chamber 102. The tissue labeling device 100 may also control other elements such as voltage of the electrodes 118, heating or cooling of a temperature control element 122, or other operating parameters to set conditions suitable for tissue labeling. As described above, this process causes the binding affinity of the labeling solution 114 to increase over time such that the labeling probes may initially penetrate the tissue sample 110 without binding at the surface (due to initially low binding affinity) and then bind to the tissue sample 110 with high uniformity.

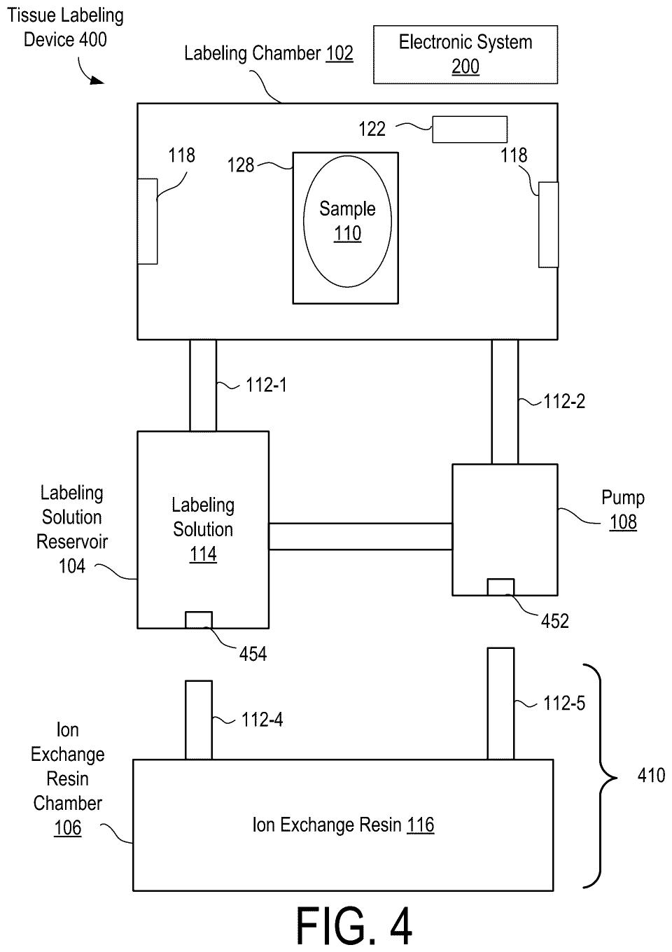

FIG. 4 illustrates an example embodiment of a resin column attachment 410 that may be attached to a tissue labeling device 400. In this embodiment, the tissue labeling device 400 may comprise similar components to the tissue labeling device 100 of FIG. 1 but can optionally operate without the ion exchange resin chamber 106 and ion exchange resin 116. In the standalone operating configuration, the labeling solution reservoir 104 and the pump 108 may include a set of plugs 454, 452 for sealing the labeling solution reservoir 104 and the pump 108 when the resin column attachment 410 is not attached. In this operating configuration, the pump 108 circulates the labeling solution 114 through the labeling chamber 102 as described above. An appropriate labeling solution 114 may be used that has a binding affinity that increases over time in response to the electrophoresis in the labeling chamber 102. For example, the labeling solution 114 in this configuration may comprise a solution initially having high pH and high concentration of detergents, resulting in an initially low binding affinity. Over time, the electrolytic reaction produces an acidic byproduct, reducing the pH while the detergent diffuses through a semipermeable membrane holding the tissue sample 110 to decrease its concentration and increase the binding affinity to high levels by the end of the labeling run.

The plugs 454, 452 may be removable to enable attachment of the resin column attachment 410, which includes the ion exchange resin 116 and a set of fluid channels 112-4, 121-5 for connecting to the labeling solution reservoir 104 and the pump 108 respectively, resulting in a configuration similar to FIG. 1.

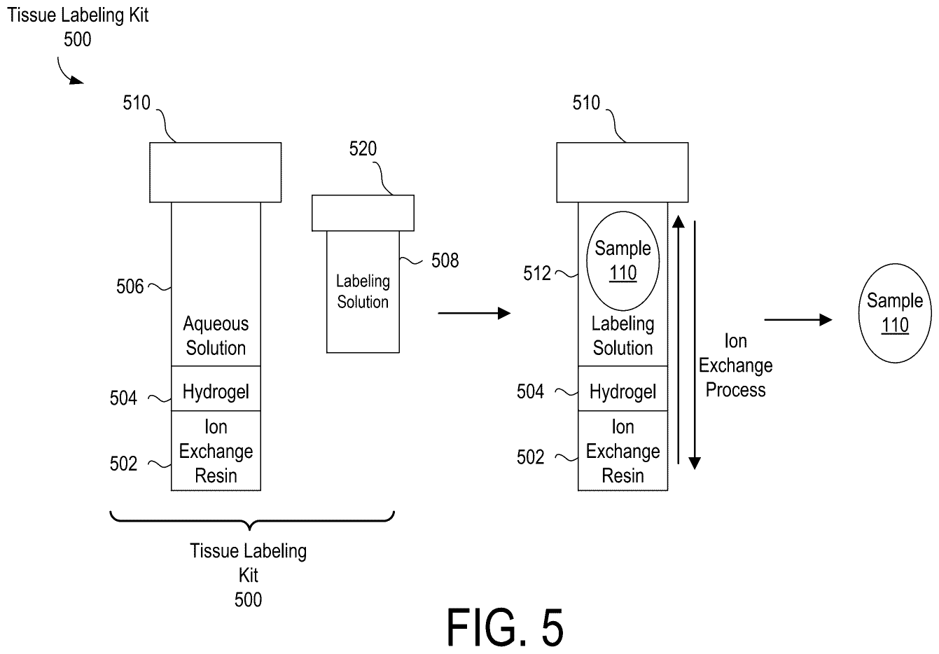

FIG. 5 illustrates an example embodiment of a labeling kit 500 for labeling a tissue sample 110. The labeling kit 500 may comprise a container 510 (such as laboratory conical tube) that contains an ion exchange resin 502 as a base layer, and a hydrogel layer 504 on top of the resin. The hydrogel layer 504 may comprise, for example, agarose, polyacrylamide, alginate, phytagel, gelatin, or a combination thereof. The container 510 may initially include aqueous solution 506 (e.g., distilled water) over the hydrogel 504 to prevent the hydrogel 504 from drying out. The labeling kit 500 may also include the labeling solution 508 in a separate container 520.

To perform labeling, the aqueous solution 506 may be removed from the container 510 and the tissue sample 110 may be placed in the container 510 together with the labeling solution 508. The ion exchange process will then occur passively in the container 510 with the ion exchange resin 502 exchanging ions with the labeling solution 512 to increase binding affinity of the labeling probes over time. The hydrogel layer 504 acts as a barrier to diffusion, thereby controlling the rate of ion exchange. The specific rate of change may be dependent on the thickness and composition of the hydrogel layer 504 (e.g., concentration or other parameters), the composition and volume of the ion exchange resin 502, the composition and volume of the labeling solution 508, the characteristics of the tissue sample 110, environmental factors such as temperature, or other conditions. The labeling solution 512 may initially have relatively low binding affinity when added to the container 510 (e.g., by virtue of it having high or low pH) and thus the labeling probes can diffuse into the tissue sample 110 with relatively little binding. Over time, the labeling solution 512 diffuses through the hydrogel layer 504 and exchanges ions with the resin 502 to slowly increase the binding affinity of the labeling probes (e.g., by decreasing pH to neutral or near neutral when the labeling solution 512 starts with a relative high pH (basic), or by increasing pH to neutral or near neutral when the labeling solution 512 starts with a relatively low pH (acidic)). Once all the ions are exchanged, the binding affinity of the labeling probes will be high to enable uniform labeling.

In another embodiment, a tissue labeling kit may include a container 510 with separately packaged ion exchange resin 502, hydrogel 504, and labeling solution 508. In this embodiment, a technician may be responsible for measuring out and adding suitable volumes of the ion exchange resin 502, hydrogel 504, and the labeling solution 508 to perform labeling of a tissue sample 110.

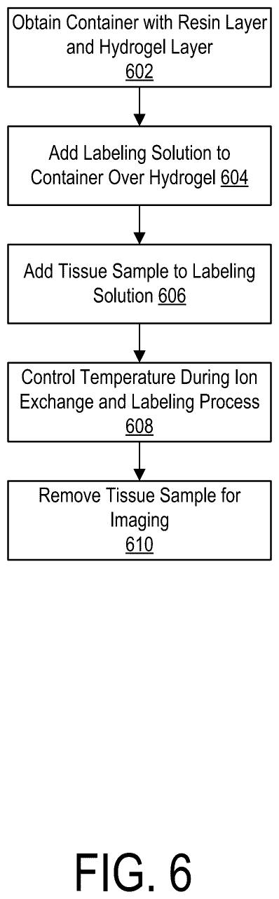

FIG. 6 is an example embodiment of a process for facilitating tissue labeling using a tissue labeling kit 500. A technician obtains 602 a container 510 including an ion exchange resin 502 and a hydrogel 504 layered over the ion exchange resin. The container 510 may be obtained from a supplier in this form, or the resin 502 and hydrogel 504 may be measured out and added by the technician. If the container 510 comes prefilled with distilled water over the hydrogel layer 504, this step may furthermore include removing the distilled water. The technician may then add 604 the labeling solution 508 over the hydrogel 504, and add 606 the tissue sample 110 to the labeling solution 508. The technician may furthermore control 608 temperature within a suitable temperature range during the ion exchange and labeling reaction. The technician may then remove the tissue sample 110 (now labeled) for imaging using a light sheet microscope or other microscope device. In further embodiments, the above-described process may be performed in automated manner (e.g., by a robotic system) instead of by a human technician.

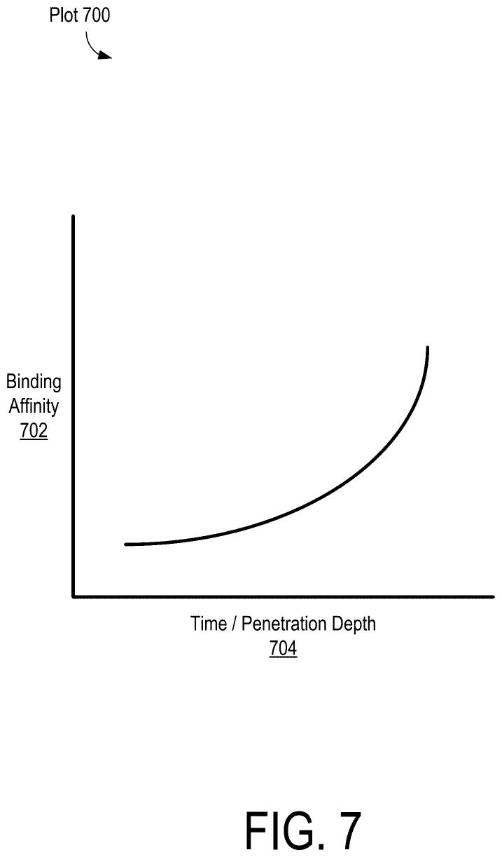

FIG. 7 is an example plot 700 showing an increase in binding affinity 702 over time 704 in an example labeling operation using the above-described techniques. As shown, the binding affinity 702 starts relatively low (or at zero in some embodiments). The labeling probes penetrate deeper into the tissue sample 110 over time while the binding affinity is still relatively low and only initially gradually increasing. Over time, the binding affinity 702 increases with increasing rate of change such that the binding affinity becomes relative high. The specific shape of the curve can be controlled such that the high level of binding affinity occurs after sufficient time 704 where high depth of penetration has occurred, thereby achieving uniform labeling.

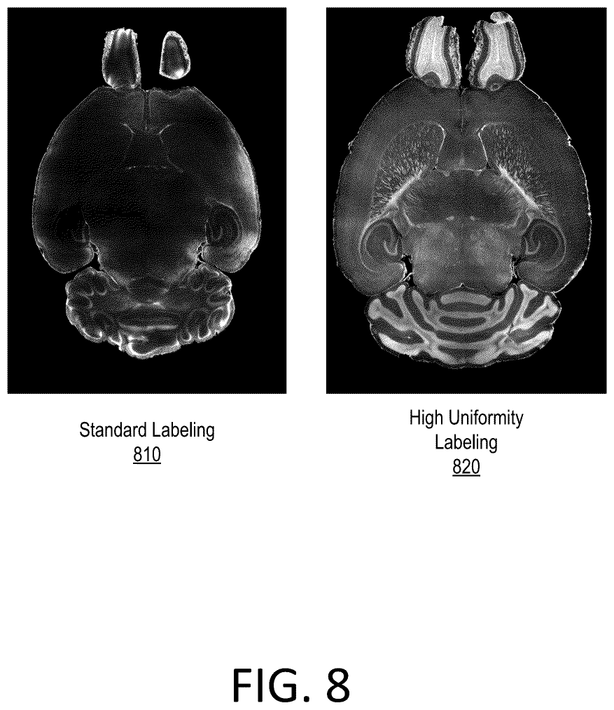

FIG. 8 are example sets of image 810, 820 showing anti-lamin B1 antibody labeling of an intact mouse brain sample. The standard labeling image 810 was obtained using an electrophoretic sweeping technique without use of the ion exchange resin. The high uniformity labeling image 820 was obtained using the labeling technique of the present disclosure in which an ion exchange resin interacts with the labeling solution to increase binding affinity. As can be seen, labeling uniformity is significantly improved in the high uniformity labeling 820, particularly in the central regions of the brain. This relatively higher labeling uniformity allows for more accurate imaging of the sample, particularly in the interior regions.

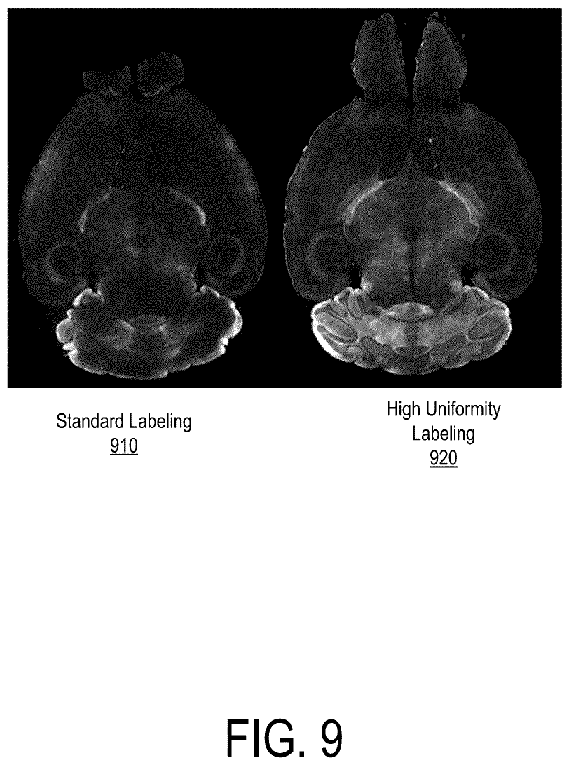

FIG. 9 is another example set of images 910, 920 comparing labeling techniques. In this example, the images 910, 920 show anti-parvalbumin antibody labeling of an intact mouse brain sample. The high uniformity labeling image 920 shows relatively higher signal strength and uniformity, particularly in the cerebellum region at the bottom of the image.

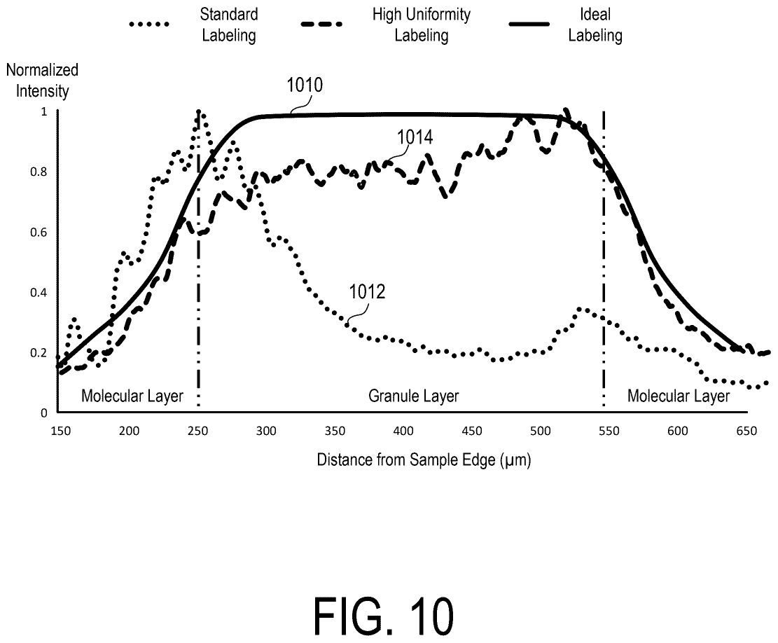

FIG. 10 is a plot illustrating comparing labeling profiles for Lamin B1 in the cerebellum under the standard labeling technique and the high uniformity labeling technique. The plot represents normalized intensity of pixels in images obtained from an imaging device (such as a light sheet microscope or other microscope device) for different distances from the edge of a tissue sample. The ideal labeling profile 1010 shows a constant normalized intensity for a region within the granule layer of the sample indicating uniform binding of labeling probes within his region. The high uniformity labeling profile 1014 (achieved using the high uniformity labeling technique described herein) achieves labeling uniformity close to the ideal labeling profile 1010 and significantly improved relative to the standard labeling profile 1012.

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope is not limited by this detailed description, but rather by any claims that issue on an application based hereon. Accordingly, the disclosure of the embodiments is intended to be illustrative, but not limiting, of the scope of the invention.

1. A tissue labeling device, comprising:
a labeling chamber for holding a tissue sample;
a labeling solution reservoir for containing a labeling solution;
a resin chamber for containing an ion exchange resin;
a pump to circulate the labeling solution from the labeling solution reservoir through the resin chamber and to circulate the labeling solution through the labeling chamber; and
wherein a binding affinity of labeling probes in the labeling solution increases as the labeling solution circulates through the resin chamber based on an ion exchange with the ion exchange resin.

2. The tissue labeling device of claim 1, wherein the binding affinity of the labeling probes increases over time in concurrence with increasing depth of penetration of the labeling solution into the tissue sample.

3. The tissue labeling device of claim 2, wherein a rate of increase of the binding affinity of the labeling probes increases over time such that the rate of change is relatively slower when the labeling solution has a lower depth of penetration into the tissue sample and the rate of increase is relatively higher when the labeling solution has a higher depth of penetration into the tissue sample.

4. The tissue labeling device of claim 1, wherein the labeling chamber includes an electrode to apply an electrical current through the labeling solution in the labeling chamber.

5. The tissue labeling device of claim 1, wherein the tissue labeling device further comprises:
a temperature sensor to sense a temperature of the labeling solution in the labeling chamber;
a temperature control element to generate heating or cooling in the labeling chamber; and
a controller to control the temperature control element based on the temperature to maintain the labeling solution in the labeling chamber within a target temperature range.

6. The tissue labeling device of claim 1, further comprising:
a first fluid channel between the labeling solution reservoir and the pump;
a second fluid channel between the pump and the resin chamber;
a third fluid channel between the resin chamber and the labeling solution reservoir;
a fourth fluid channel between the pump and the labeling chamber; and
a fifth fluid channel between the labeling chamber and the labeling solution reservoir.

7. The tissue labeling device of claim 1, further comprising:
a controller to control operation of the tissue labeling device in a first operating mode for tissue clearing, and to control operation of the tissue labeling device in a second operation mode for tissue labeling.

8. The tissue labeling device of claim 1, wherein the labeling solution comprises an initially high pH solution.

9. The tissue labeling device of claim 8, wherein the ion exchange resin interacts with the labeling solution to neutralize the initially high pH of the labeling solution.

10. A tissue labeling kit, comprising:
a tube containing:
an ion exchange resin layer;
a hydrogel over the ion exchange resin layer; and
an aqueous solution over the hydrogel in the tube; and
a labeling solution container containing a labeling solution, wherein the labeling solution includes labeling probes that bind to target molecules of a tissue sample with a binding affinity that increases when the labeling solution interacts with the ion exchange resin in an ion exchange process.

11. The tissue labeling kit of claim 10, wherein the hydrogel comprises at least one of: agarose, polyacrylamide, alginate, phytagel, gelatin, or a combination thereof, and wherein the hydrogel operates to control a rate of the ion exchange process.

12. The tissue labeling kit of claim 10, wherein the labeling solution comprises an initially high pH solution.

13. The tissue labeling kit of claim 12, wherein the ion exchange resin interacts with the labeling solution to neutralize the initially high pH of the labeling solution.

14. The tissue labeling kit of claim 10, wherein a rate of increase of the binding affinity increases over time.

15. A method for performing tissue labeling in a tissue labeling device, the method comprising:
holding a tissue sample in a labeling chamber;
storing labeling solution in a labeling solution reservoir;
storing an ion exchange resin in a resin chamber; and
controlling a pump to circulate the labeling solution from the labeling solution reservoir through the resin chamber and to circulate the labeling solution through the labeling chamber, such that a binding affinity of labeling probes in the labeling solution increases as the labeling solution circulates through the resin chamber based on an ion exchange with the ion exchange resin.

16. The method of claim 15, wherein the binding affinity of the labeling probes increases over time in concurrence with increasing depth of penetration of the labeling solution into the tissue sample.

17. The method of claim 15, wherein a rate of increase of the binding affinity of the labeling probes increases over time such that the rate of change is relatively slower when the labeling solution has a lower depth of penetration into the tissue sample and the rate of increase is relatively higher when the labeling solution has a higher depth of penetration into the tissue sample.

18. The method of claim 15, further comprising:
controlling a set of electrodes in the labeling chamber to apply an electrical current through the labeling solution in the labeling chamber.

19. The method of claim 15, further comprising:
sensing, by a temperature sensor, a temperature of the labeling solution in the labeling chamber; and
generating heating or cooling in the labeling chamber based on the temperature to maintain the labeling solution in the labeling chamber within a target temperature range.

20. The method of claim 15, further comprising:
operating the tissue labeling device in a tissue clearing mode to clear the tissue sample prior to tissue labeling.
